(19) United States
(12) Patent Application Publication
(10) Pub. No.: US 2022/0306003 A1
(43) Pub. Date: Sep. 29, 2022

(54) VEHICLE, CONTROL METHOD, AND STORAGE MEDIUM

(71) Applicant: HONDA MOTOR CO., LTD., Tokyo (JP)

(72) Inventors: Ryo Morosawa, Tokyo (JP); Haisong Liu, Tokyo (JP)

(21) Appl. No.: 17/680,397

(22) Filed: Feb. 25, 2022

(30) Foreign Application Priority Data
Mar. 24, 2021 (JP) 2021-050583

(51) Int. Cl. B60R 3/02; G06V 20/58; G06V 40/10; G06V 20/59; B60W 60/00

(52) U.S. Cl. CPC B60R 3/02; G06V 20/58; G06V 40/10; G06V 20/59; B60W 60/001

(57) ABSTRACT

A vehicle includes: a footstep used to get on or off the vehicle; a driving unit configured to drive the footstep so that at least a part of the footstep is accommodated at an accommodation position hidden in a body of the vehicle; an imaging unit configured to image a vicinity of the vehicle; a person detection unit configured to detect a person from an image captured by the imaging unit; a user determination unit configured to determine whether the person detected by the person detection unit is a registered user who has been registered in advance; and a first control unit configured to control the driving unit such that the footstep is moved from the accommodation position to a use position at which at least a part of the footstep is exposed to outside of the vehicle when the user determination unit determines that the person is the registered user, and the footstep is moved to the accommodation position after the person gets on the vehicle.

### CROSS-REFERENCE TO RELATED APPLICATION

Priority is claimed on Japanese Patent Application No. 2021-050583, filed Mar. 24, 2021, the content of which is incorporated herein by reference.

### BACKGROUND OF THE INVENTION

### Field of the Invention

The present invention relates to a vehicle, a control method, and a storage medium.

### Description of Related Art

In the related art, various technologies for supporting users getting on vehicles have been proposed. For example, various keyless entry systems have been proposed with regard to door locking of vehicles. As a related technology, a keyless entry system that images an iris of a person touching a doorknob and performs authentication using information regarding the imaged iris has been proposed (for example, see Japanese Unexamined Patent Application, First Publication No. 2003-138817).

### SUMMARY OF THE INVENTION

However, in some technologies of the related art, users may have to adopt uncomfortable postures when the users get on vehicles, and thus the users cannot get on the vehicle easily.

Aspects of the present invention have been considered in view of the foregoing circumstances and an objective of the present invention is to provide a vehicle, a control method, and a storage medium enabling a user to get on a vehicle easily.

To solve the foregoing problem and achieve the objective, the following aspects are adopted in the present invention.

(1) According to an embodiment of the present invention, a vehicle includes: a footstep used to get on or off the vehicle; a driving unit configured to drive the footstep so that at least a part of the footstep is accommodated at an accommodation position hidden in a body of the vehicle; an imaging unit configured to image a vicinity of the vehicle; a person detection unit configured to detect a person from an image captured by the imaging unit; a user determination unit configured to determine whether the person detected by the person detection unit is a registered user who has been registered in advance; and a first control unit configured to control the driving unit such that the footstep is moved from the accommodation position to a use position at which at least a part of the footstep is exposed to outside of the vehicle when the user determination unit determines that the person is the registered user, and the footstep is moved to the accommodation position after the person gets on the vehicle.

(2) In the vehicle according to the aspect of (1), even if the user determination unit determines that the person is not the registered user, the first control unit may be able to move the footstep to the use position when the person already determined to be the registered user is getting on the vehicle.

(3) The vehicle according to the aspect of (1) or (2) may further include a build determination unit configured to determine a build of a person detected by the person detection unit on the basis of an image captured by the imaging unit. The first control unit may control the driving unit such that a height of the footstep at the use position becomes a height in accordance with the build determined by the build determination unit.

(4) The vehicle according to any one of the aspects of (1) to (3) may further include an action detection unit configured to detect an action of a passenger inside the vehicle. On the basis of a detection result of the action detection unit, the first control unit may control the driving unit such that the footstep is moved to the use position.

(5) The vehicle according to any one of the aspects of (1) to (4) may further include an article accommodation unit configured to accommodate an article; an article detection unit configured to detect an article on the footstep; an accommodation mechanism configured to move the article on the footstep to the article accommodation unit; and a second control unit configured to control the accommodation mechanism such that the article detected by the article detection unit is moved to the article accommodation unit.

(6) In the vehicle according to the aspect of (5), the first control unit may control the driving unit such that the footstep is moved to the use position when a passenger gets off the vehicle. The second control unit may control the accommodation mechanism such that an article accommodated in the article accommodation unit is moved to the footstep moved to the use position.

(7) The vehicle according to the aspect of (6) may further include a luggage detection unit configured to detect an item of luggage left by a passenger who is getting off the vehicle. The second control unit may not move the article to the footstep when the luggage detection unit detects the left item of luggage.

(8) The vehicle according to any one of the aspects of (1) to (7) may further include a luggage detection unit configured to detect an item of luggage left by a passenger who is getting off the vehicle; and a report unit configured to report the left item of luggage when the luggage detection unit detects the left item of luggage.

(9) In the vehicle according to any one of the aspects of (1) to (8), the vehicle may be an automated driving vehicle. The first control unit may be able to control the driving unit such that the footstep is moved to the use position when the vehicle is stopping at a scheduled location.

(10) According to another embodiment of the present invention, a control method causes a computer mounted in a vehicle including a footstep that is used to get on or off the vehicle, a driving unit that drives the footstep so that at least a part of the footstep is accommodated at an accommodation position hidden in a body of the vehicle, and an imaging unit that images a vicinity of the vehicle, to perform: detecting a person from an image captured by the imaging unit; determining whether the detected person is a registered user who has been registered in advance; and controlling the driving unit such that the footstep is moved from the accommodation position to a use position at which at least a part of the footstep is exposed to outside of the vehicle when the person is determined to be the registered user, and the footstep is moved to the accommodation position after the person gets on the vehicle.

(11) According to still another embodiment of the present invention, a computer-readable non-transitory stores a program causing a computer mounted in a vehicle including a footstep that is used to get on or off the vehicle, a driving unit that drives the footstep so that at least a part of the footstep is accommodated at an accommodation position hidden in a body of the vehicle, and an imaging unit that images a vicinity of the vehicle, to perform: detecting a person from an image captured by the imaging unit; determining whether the detected person is a registered user who has been registered in advance; and controlling the driving unit such that the footstep is moved from the accommodation position to a use position at which at least a part of the footstep is exposed to outside of the vehicle when the person is determined to be the registered user, and the footstep is moved to the accommodation position after the person gets on the vehicle.

According to (1) to 11), the user can get on the vehicle conveniently.

### BRIEF DESCRIPTION OF THE DRAWINGS

FIG. 1A is a diagram illustrating an exemplary configuration of a vehicle M according to an embodiment.

FIG. 1B is a diagram illustrating an exemplary configuration of the vehicle M according to the embodiment.

FIGS. 2A and 2B are diagrams illustrating an example when a footstep 120 is moved to a use position.

FIGS. 3A to 3C are diagrams illustrating an example of a shoes-accommodation unit 300.

FIG. 4 is a block diagram illustrating an exemplary functional configuration of the vehicle M.

FIG. 5 is a flowchart illustrating an example of a process before boarding performed in the vehicle M starts.

FIG. 6 is a flowchart illustrating an example of a process of boarding performed in the vehicle M.

FIG. 7 is a diagram illustrating an example of a passenger table 700 stored in a storage unit 410.

FIG. 8 is a flowchart illustrating an example of a process at the time of alighting performed in the vehicle M.

FIGS. 9A and 9B are diagrams illustrating an example of a footstep 900 according to Modified Example 1.

FIG. 10 is a diagram illustrating an example of a footstep 1000 according to Modified Example 2.

FIGS. 11A to 11D are diagrams illustrating an example of a footstep 1100 according to Modified Example 3.

FIGS. 12A and 12B are diagrams illustrating an example of a footstep 1200 according to Modified Example 4.

FIGS. 13A and 13B are diagrams illustrating an example of a footstep 1300 according to Modified Example 5.

### DETAILED DESCRIPTION OF THE INVENTION

Hereinafter, an embodiment of a vehicle, a control method, and a storage medium according to the present invention will be described with reference to the drawings. In the embodiment, authenticating the face of a surrounding person using an imaging result of a camera imaging the outside of a vehicle and moving a footstep to a use position will be described.

### Embodiment

### System Configuration of Vehicle System St

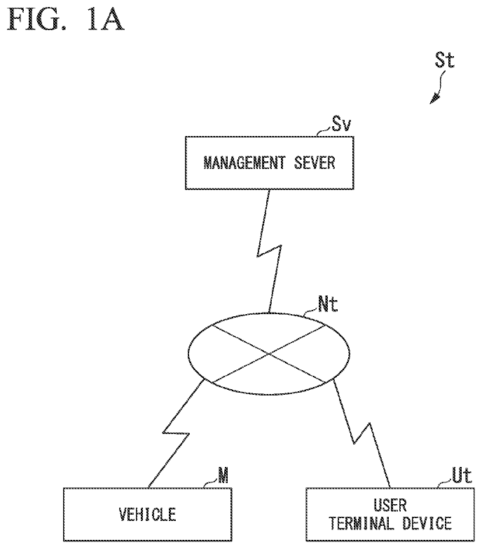

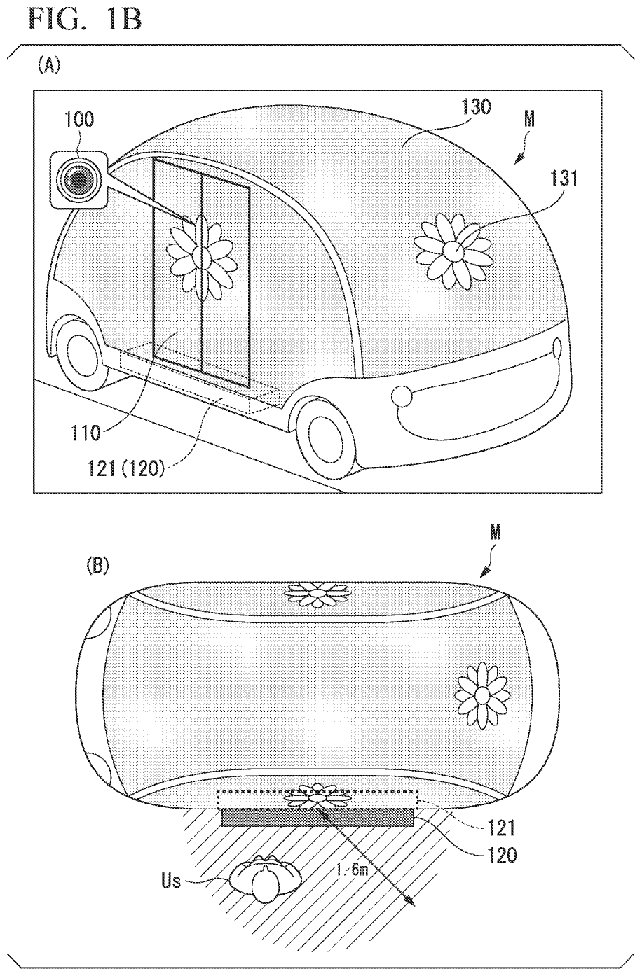

First, an embodiment will be described. FIG. 1A is a diagram illustrating an exemplary system configuration of a vehicle system St according to the embodiment. As illustrated in FIG. 1A, the vehicle system St includes a vehicle M, a user terminal device Ut, and a management server Sv. The vehicle M, the user terminal device Ut, and the management server Sv are connected to be able to communicate via a network Nt.

The vehicle M is a vehicle that performs automated driving without a driver seat. Specifically, the vehicle M includes various sensors and controls driving using detection results of the various sensors. The vehicle M controls driving on the basis of an instruction of the management server Sv. The control of the driving includes, for example, steering control and speed control.

The user terminal device Ut is a terminal device used by a user. The user terminal device Ut is, for example, a smartphone, a tablet device, a PC, or the like. A predetermined application related to the vehicle system St is installed in the user terminal device Ut. The user terminal device Ut accepts an input of schedule information or profile information of the user related to use of the vehicle M. The schedule information is information indicating a schedule of an action of the user. The information indicating an action schedule of the user includes, for example, information regarding a time and information regarding a location. The profile information includes not only information regarding the face (a feature amount of the face) or an address of the user but also information regarding an address book of acquaintances or information regarding the faces of the acquaintances.

The management server Sv receives the schedule information, the profile information or the like of the user from the user terminal device Ut and manages the schedule information, the profile information, or the like. For example, the management server Sv causes the vehicle M to go and pick up the user in front of her or his home at a schedule time on the basis of the schedule information of the user. When the face of the user is authenticated, the vehicle M opens a door, allows the user to get on the vehicle M, and causes the user to arrive at a destination at a scheduled arrival time.

Control of driving of the vehicle M will be supplemented. For example, when adaptive cruise control (ACC) is performed, the vehicle M performs accelerating or decelerating control (speed control) based on an inter-vehicle distance to a front vehicle such that the vehicle M travels while constantly maintaining an inter-vehicle distance between the vehicle M and the front vehicle on the basis of information acquired by an object recognition device (not illustrated) mounted in the vehicle M. For example, when a lane keep assist system (LKAS) is performed, the vehicle M performs steering control such that the vehicle M travels while keeping a traveling lane in which the vehicle M is traveling currently (lane keeping). For example, when a collision mitigation brake system (CMBS) is performed, the vehicle M performs decelerating control or stopping control of the vehicle M in a case in which an inter-vehicle distance to the front vehicle is less than a predetermined distance.

### Configuration of Vehicle M

FIG. 1B is a diagram illustrating an exemplary configuration of the vehicle M according to the embodiment. As illustrated in FIG. 1B(A), the vehicle M is covered with an opaque glass 130. The glass 130 can be electrified and can be switched between a transparent state and a semi-transparent (opaque) state in accordance with switching between the electrification and non-electrification. The vehicle M goes and picks up the user in front of her or his home at a schedule time. When the vehicle M arrives at the home of the user, the vehicle M notifies the user terminal device Ut of the arrival through the management server Sv.

The vehicle M causes the glass 130 to become semi-transparent, goes to the home of the user, and waits until the user comes. During the waiting, a temperature inside the vehicle is managed to a preset temperature. A symbol 131 customized by the user can be displayed on the glass 130. Thus, the user approaching the vehicle M can easily find the vehicle M owned by the user.

In the vehicle M, a slide door 110 is equipped. The slide door 110 is an automatic sliding type door. The door of the vehicle M is not limited to the sliding type door, and a hinged type door or a folding type door can also be used.

A vehicle exterior camera 100 (which is an example of an imaging unit) that images the outside is disposed in the middle of the slide door 110. The vehicle exterior camera 100 images a vicinity of the vehicle M. The vehicle exterior camera 100 normally images a position at which an image of the face of a person can be obtained. For example, the vehicle exterior camera 100 images a person approaching the vehicle M within a height range of a 0.5 m to 2.5 m.

The vehicle exterior camera 100 can operate in any one mode between a high power mode and a low power mode. The high power mode is a mode in which imaging is performed with high precision (high resolution) and power consumption is high. The low power mode is a mode in which imaging is performed with low precision (low resolution) and power consumption is low. The vehicle exterior camera 100 normally operates in the low power mode during stopping. In the embodiment, one vehicle exterior camera 100 is assumed to capture images with high and low resolutions, but the present invention is not limited thereto. A camera for a high resolution and a camera for a low resolution may be separately provided.

The vehicle exterior camera 100 is a small camera. For example, a charge coupled device (CCD) camera or a complementary metal oxide semiconductor (CMOS) camera is used. The vehicle exterior camera 100 operates using electricity accumulated in the battery 220. An image captured by the vehicle exterior camera 100 is, for example, a moving image, but may be a still image.

The vehicle exterior camera 100 is provided to correspond to, for example, the slide door 110. Specifically, for example, when the slide door 110 is provided on only the left side centering on a vehicle traveling direction, the vehicle exterior camera 100 may be provided on only the left side. The present invention is not limited to the case in which the vehicle exterior camera 100 is provided to correspond to the slide door 110. For example, the vehicle exterior camera 100 may be provided at a position at which a vicinity of the vehicle M can be imaged. Specifically, the vehicle exterior camera 100 can also be provided at any position such as a front or rear portion of the vehicle M. Appearance of footstep 120

The vehicle M is a vehicle on which a passenger takes off shoes 210 and gets on. In FIG. 1B(A), the footstep 120 (which is an example of a footstep) is accommodated in the footstep accommodation unit 121 below the slide door 110. The footstep 120 is connected to the footstep accommodation unit 121 and is connected to a movement mechanism (hereinafter referred to as a “footstep movement mechanism”) that enables movement to a use position illustrated in FIG. 1B.

As illustrated in FIG. 1B(B), when a registered user Us entering a predetermined range (for example, a range of 1.6 m) of the vehicle M is detected using an imaging result of the vehicle exterior camera 100, the vehicle M controls the footstep movement mechanism such that the footstep 120 accommodated in the footstep accommodation unit 121 is moved to a use position. The use position of the footstep 120 is a position at which extrusion starts from the casing of the vehicle M. The footstep 120 is disposed at the use position when a passenger gets on or off the vehicle and is accommodated in the footstep accommodation unit 121 after the passenger completely gets on or off the vehicle.

### [Use at Use Position of Footstep 120]

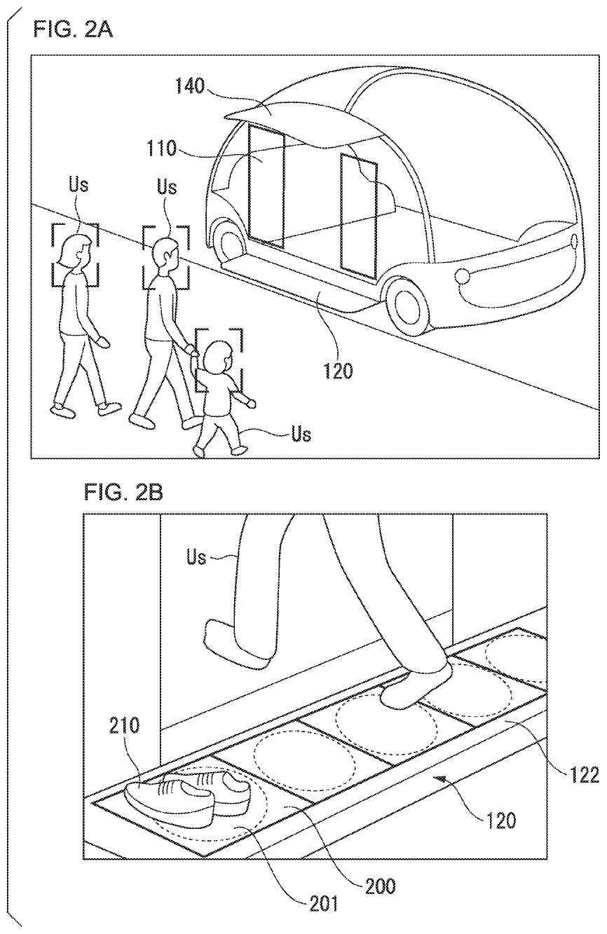

FIGS. 2A and 2B are diagrams illustrating an example when the footstep 120 is moved to the use position. FIG. 2A illustrates the vehicle M when the registered user Us approaches. In FIG. 2A, the vehicle M changes the glass 130 to a transparent state when the registered user Us is detected. Thus, the registered user Us can ascertain that the vehicle M recognizes the registered user Us.

As illustrated in FIG. 2A, the vehicle M moves the footstep 120 to the use position. Further, the vehicle M causes a hood 140 to appear. The vehicle M opens the slide door 110. Specifically, when the registered user Us performs a predetermined manipulation within 1 m from the vehicle M, a motion sensor included in the vehicle M detects the manipulation. When the manipulation is detected, the vehicle M opens the slide door 110.

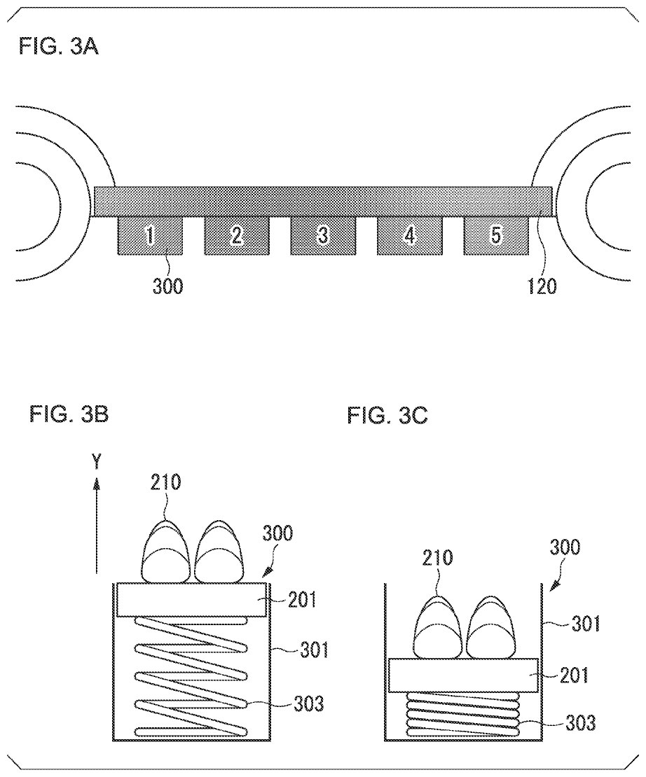

FIG. 2B illustrates the details of the footstep 120 and an aspect at the time of getting on the vehicle. As illustrated in FIG. 2B, the footstep 120 includes a footstep casing 122. A plurality of shoes-takeoff regions 200 are provided in the footstep casing 122. The number of shoes-takeoff regions 200 is a number corresponding to a riding capacity and is, for example, “five,” as illustrated. The shoes-takeoff region 200 is provided to correspond to a shoes-accommodation unit 300 (see FIGS. 3A to 3C) to be described below. The shoes-takeoff region 200 includes a rotatable rotation base 201.

In the shoes-takeoff region 200, a lighting member such as a light-emitting diode (LED) is provided. The lighting member is turned on to correspond to the shoes-accommodation unit 300 which is not being used. Thus, a passenger can be prompted to take off shoes in an optimum shoes-takeoff region 200. The LED may be provided in the rotation base 201 in the shoes-takeoff region 200 or may be provided at a position other than in the rotation base 201.

The registered user Us takes off the shoes 210 in the shoes-takeoff region 200 (the rotation base 201) on the footstep 120 and gets on the vehicle M. When the registered user Us gets on the vehicle, the vehicle M accommodates the shoes 210 in the shoes-accommodation unit 300 (see FIGS. 3A to 3C) and returns the footstep 120 to the footstep accommodation unit 121. When the registered user Us gets on the vehicle, the vehicle M ensures privacy during the boarding by causing the glass 130 to become semi-transparent. Transparency or a pattern of the glass 130 during boarding can be appropriately changed in accordance with setting.

### Example of Shoes-Accommodation Unit 300

FIGS. 3A to 3C are diagrams illustrating an example of the shoes-accommodation unit 300. In FIG. 3A, the shoes-accommodation units 300 are provided according to the riding capacity (for example, five people). Identification numbers 1 to 5 are allocated as identification information to the shoes-accommodation units 300 from the left. The shoes 210 on the shoes-takeoff region 200 are accommodated in the shoes-accommodation unit 300.

FIG. 3B is a diagram illustrating an exemplary configuration of the movement mechanism included in the shoes-accommodation unit 300. In FIG. 3B, the shoes-accommodation unit 300 (which is an example of an article accommodation unit) includes the rotation base 201, an accommodation casing 301, and a biasing spring 303 as the movement mechanism. The rotation base 201 forms a part of the shoes-takeoff region 200, that is, a part of the footstep 120. The biasing spring 303 is an elastic member that urges the rotation base 201 upward or downward. A position of the rotation base 201 illustrated in FIG. 3B is referred as an “upper position.” When the registered user Us gets on the vehicle, the rotation base 201 is locked at the upper position so that the rotation base 201 does not move in the vertical direction (the Y direction in the drawing).

FIG. 3C is a diagram illustrating an operation of the shoes-accommodation unit 300 when the footstep 120 is accommodated. As illustrated in FIG. 3C, the rotation base 201 is urged downward by the biasing spring 303 to be displaced downward. A position of the rotation base 201 illustrated in FIG. 3C is referred to as a “lower position.” The lower position is a position at which the rotation base 201 is displaced downward so that the upper portion of the shoes 210 does not protrude from the accommodation casing 301.

In this way, by accommodating the shoes 210 in the accommodation casing 301, the shoes 210 can also be accommodated in the footstep accommodation unit 121 along with the footstep 120. Since the footstep accommodation unit 121 does not have a size in consideration of a space for the shoes 210, it is possible to prevent the size of the footstep accommodation unit 121 from becoming large. In the shoes-accommodation unit 300, a cover that covers an opening (an upper side) of the accommodation casing 301 may be provided at the lower position.

### [Rotation of Rotation Base 201]

The rotation base 201 is configure to be able to rotate about a line of the Y direction in the drawing, that is, the shoes-accommodation unit 300 includes a rotation mechanism that changes the direction of the toes of the shoes 210 by 180 degrees. The shape of the rotation base 201 is, for example, circular. Thus, during alighting, the direction of the shoes 210 is oriented to an opposite direction to the direction during boarding and the shoes 210 can be put on the footstep 120. A timing at which the rotation base 201 is rotated can be any timing after completion of boarding before a passenger gets off the vehicle.

The vehicle M moves the footstep 120 to the use position during alighting. At this time, as illustrated in FIG. 3B, the rotation base 201 is urged upward by the biasing spring 303, is moved to the upper position, and is locked. The direction of the shoes 210 becomes a direction opposite to the direction during boarding. Therefore, the registered user Us can conveniently get off the vehicle.

The shape of the rotation base 201 may be any shape other than a circle. When the shape of the rotation base 201 is a shape other than a circle, a gap for rotating the rotation base 201 may be provided in the accommodation casing 301. In the upward direction (the Y direction) in the drawing, a position to which the rotation base 201 is rotated may be any position between the upper position and the lower position of the rotation base 201 or may be a position protruding from the accommodation casing 301 when the rotation base 201 is displaced further upward from the upper position.

### Functional Configuration of Vehicle M

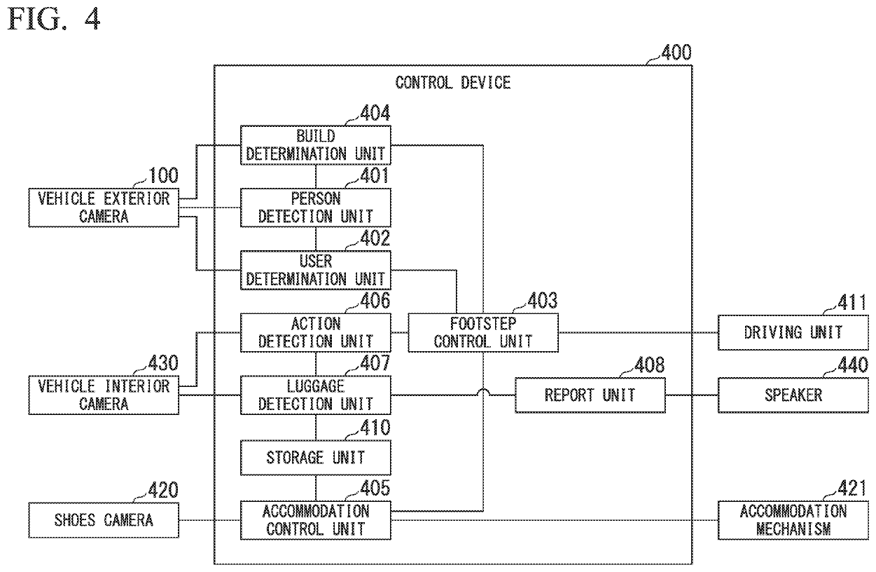

FIG. 4 is a block diagram illustrating an exemplary functional configuration of the vehicle M. The vehicle M includes a control device 400. The control device 400 is implemented by, for example, an electronic control unit (ECU). The control device 400 includes a person detection unit 401, a user determination unit 402, a footstep control unit 403 (which is an example of a first control unit), a build determination unit 404, an accommodation control unit 405 (which is an example of a second control unit), an action detection unit 406, a luggage detection unit 407, and a report unit 408. Such constituent elements are each implemented, for example, by causing a hardware processor such as a central processing unit (CPU) to execute a program (software). Some or all of the constituent elements may be implemented by hardware (a circuit unit circuitry) such as a large scale integration (LSI), an application specific integrated circuit (ASIC), a field-programmable gate array (FPGA), or a graphics processing unit (GPU) or may be implemented in combination of software and hardware. The program may be stored in advance in a storage device (not illustrated) such as an HDD or a flash memory of the control device 400 or may be stored in a storage medium such as a DVD or CD-ROM which can be detachably mounted, and thus the storage medium may be mounted on a drive device to be installed in the HDD or the flash memory of the control device 400.

The control device 400 includes a storage unit 410. The storage unit 410 is implemented by, for example, a storage device such as a random access memory (RAM), a read-only memory (ROM), a hard disk drive (HDD), or a flash memory. Information stored in the storage unit 410 may be stored in an external device (for example, the management server Sv) which can access the control device 400.

The person detection unit 401 detects a person approaching the vehicle M from an image captured by the vehicle exterior camera 100. Specifically, the person detection unit 401 detects the face of a person near the vehicle M at a low resolution using an imaging result of the vehicle exterior camera 100 operating in the low power mode. The person detection unit 401 can normally detect the face of the surrounding person at the low resolution when the vehicle M is stopping (or is parked) at a scheduled location. The person detection unit 401 analyzes the image with the low resolution, extracts a feature amount of the face, and authenticates the face of the person.

The user determination unit 402 determines whether the person detected by the person detection unit 401 is the registered user Us who has been registered in advance. Specifically, when the person detection unit 401 detects the person, the user determination unit 402 operates the vehicle exterior camera 100 in the high power mode and performs user determination (authentication) at the high resolution to determine whether the face of the person detected by the person detection unit 401 is the face of the registered user Us who has been registered in advance. When the vehicle M includes the plurality of vehicle exterior cameras 100, the user determination unit 402 operates the vehicle exterior camera 100 disposed in a direction in which a person approaches in the high power mode. Specifically, when a person approaches from the left side, the user determination unit 402 operates the vehicle exterior camera 100 disposed on the left side in the high power mode.

The registered user Us is, for example, an owner, a family member, or the like of the vehicle M. The user determination unit 402 analyzes an image with the high resolution, extracts a feature amount of the face, matches the feature amount with a feature amount registered in advance in a database of the management server Sv, and identifies a person with a highest matching score. When the identified person is the owner of the vehicle M, the authentication is successful.

Hereinafter, the user determination is also referred to as “authentication” in some cases. In the user determination, determination that a person is the registered user Us is also referred to as “success in the authentication of the registered user Us” in some cases. In the user determination, determination that a person is not the registered user Us is referred to as “failure of the authentication of the registered user Us” in some cases.

The driving unit 411 drives the footstep 120 so that the footstep 120 is accommodated at the accommodation position. The accommodation position is a position at which the footstep accommodation unit 121 is disposed. In the embodiment, the footstep 120 is entirely hidden at the accommodation position. At least a part of the footstep 120 may be hidden by the body of the vehicle M at the accommodation position.

When the user determination unit 402 determines that the user is the registered user Us, the footstep control unit 403 moves the footstep 120 accommodated in the footstep accommodation unit 121 to the use position. The use position is a position at which the footstep 120 is most advanced. The use position may be a position at which at least a part of the footstep 120 is exposed to the outside of the vehicle M from the accommodation position. The footstep control unit 403 accommodates the footstep 120 in the footstep accommodation unit 121 after the registered user Us gets on the vehicle. The footstep control unit 403 controls the driving unit 411 such that the footstep 120 is moved to the accommodation position after the person gets on the vehicle. After the registered user Us gets on the vehicle, the slide door 110 is closed and locked.

As a plurality of persons approach the vehicle M, the user determination is performed on the plurality of persons in some cases. In these cases, when at least one person is determined to be the registered user Us in the user determination, the footstep control unit 403 may move the footstep 120 to the use position. When there is a person who is determined not to be the registered user Us in the user determination, a permission for the person to get on the vehicle may be allowed to be accepted from the registered user Us. When the permission is accepted, the person can be allowed to get on the vehicle.

### Boarding of Acquaintance

Here, while the registered user Us is getting on the vehicle M, the vehicle M goes and picks up an acquaintance in some cases. In these cases, when the footstep 120 cannot be moved to the use position, the acquaintance cannot get on the vehicle M conveniently. Accordingly, even when a person trying to get on the vehicle is not the registered user Us, the footstep control unit 403 can move the footstep 120 to the use position. Specifically, even when the user determination unit 402 determines that the person is not the registered user Us, the footstep control unit 403 can move the footstep 120 to move the use position while the person already determined to be the registered user Us is getting on the vehicle.

For example, while the registered user Us is already getting on the vehicle, the user determination unit 402 may determine whether a person approaching the vehicle M is an acquaintance of the registered user Us with reference to schedule information of the registered user Us, an address length, profile information, information regarding a present location, or the like. When the user determination unit 402 determines that the person is an acquaintance, the footstep control unit 403 may be able to move the footstep 120 to the use position.

The vehicle M may obtain information indicating that an acquaintance gets on the vehicle at a predetermined time and a predetermined location in advance from the user terminal device Ut carried by the acquaintance. However, when the user determination unit 402 determines that the user is not the registered user Us, the footstep control unit 403 can move the footstep 120 to the use position.

The registered user Us may be in charge of determining whether the footstep 120 is moved to the use position. Specifically, when the footstep control unit 403 inquires of the registered user Us about whether to allow the acquaintance to get on the vehicle and obtains a reply indicating that the acquaintance may get on the vehicle from the registered user Us, the footstep control unit 403 may move the footstep 120 to the use position. When the footstep 120 is moved to the use position, the slide door 110 is also able to be opened. The registered user Us may also be in charge of determining whether to open the slide door 110.

### Height of Footstep 120

Next, setting of the footstep 120 at a height corresponding to a build of the registered user Us will be described. The build determination unit 404 determines a build of a person detected by the person detection unit 401 on the basis of an imaging result of the vehicle exterior camera 100. The build is, for example, a body height. The build determination unit 404 determines (classifies) body heights to five stages, for example, less than 120 cm, 120 cm to 140 cm, 140 cm to 160 cm, 160 cm to 180 cm, and 180 cm or more. The build determination unit 404 determines a build of a person using, for example, an image with a low resolution. Here, the build determination unit 404 may operate the vehicle exterior camera 100 in the high power mode and determine a build of a person using an image with a high resolution.

The footstep control unit 403 controls the driving unit 411 such that a height of the footstep 120 at the use position is set to a height (for example, one height of the five stages) in accordance with the build determined by the build determination unit 404. For example, the footstep control unit 403 is located at a position at which the use position of the footstep 120 is higher as the body height is larger. When a plurality of persons get on the vehicle simultaneously, the footstep control unit 403 may set, for example, the height of the footstep 120 to a height in accordance with a person with the lowest body height or may calculate an average body height and set the height of the footstep 120 to a height in accordance with the average body height.

### [Footstep 120 During Alighting]

Next, movement of the footstep 120 to the use position when a passenger gets off the vehicle will be described. A vehicle interior camera 430 images a vehicle interior. Specifically, the vehicle interior camera 430 images a passenger in the vehicle, a position of the passenger getting on the vehicle, or an item of luggage or the like inside the vehicle.

The action detection unit 406 detects an action of a passenger in the vehicle on the basis of an imaging result of the vehicle interior camera 430. An operation of a passenger detected by the action detection unit 406 is, for example, an alighting action. The alighting action is, for example, an action in which the passenger stands up and approaches the slide door 110. In the detection of the alighting action, the passenger who will get off the vehicle is also detected.

In the detection of the passenger getting off the vehicle, the action detection unit 406 may take information regarding a destination of the passenger into consideration. Specifically, when the action in which the passenger stands up and approaches the slide door 110 is detected, a present location is the destination, and a present time is a scheduled arrival time, the action detection unit 406 may detect the action which is the alighting action. The information regarding the destination is input for each passenger. The information regarding the destination may be obtained from schedule information or may be obtained by asking a destination of each passenger during boarding.

The footstep control unit 403 controls the driving unit 411 on the basis of a detection result of the action detection unit 406 to move the footstep 120 to the use position. Specifically, when the action detection unit 406 detects an action of a passenger of getting off the vehicle and the vehicle is stopping, the footstep control unit 403 moves the footstep 120 to the use position. The footstep control unit 403 moves the footstep 120 to the use position when the present location of the vehicle M is the destination with reference to the information regarding the destination.

When the footstep 120 is moved to the use position, the slide door 110 can also be opened. When the alighting of the passenger is completed, the footstep 120 is accommodated in the footstep accommodation unit 121. When the alighting of the passenger is completed, the slide door 110 is automatically closed and locked.

A button for manually closing the slide door 110 is included in the vehicle M. When the button is pressed, the slide door 110 can also be closed. When the slide door 110 is locked, a locking sound is output. Thus, a person getting off the vehicle can confirm the locking. When everybody gets off the vehicle, the glass 130 of the vehicle M becomes semi-transparent. Thus, a risk of theft can be reduced.

### Control in Accommodation of Shoes 210 in Shoes-Accommodation Unit 300

Next, control in accommodation of the shoes 210 on the footstep 120 in the shoes-accommodation unit 300 will be described. A shoes camera 420 is an example of an article detection unit that detects the shoes 210 (which are an example of an article) on the footstep 120. In the embodiment, the shoes camera 420 serving as the article detection unit is used, but the present invention is not limited thereto. A gravimetric sensor detecting the weight of the shoes 210 may be used. Besides, when a wireless tag is mounted on the shoes 210, the article detection unit may be a sensor that detects the wireless tag.

An accommodation mechanism 421 is a mechanism that moves the shoes 210 on the footstep 120 to the shoes-accommodation unit 300. Specifically, the accommodation mechanism 421 includes a movement mechanism and a rotation mechanism illustrated in FIG. 3B.

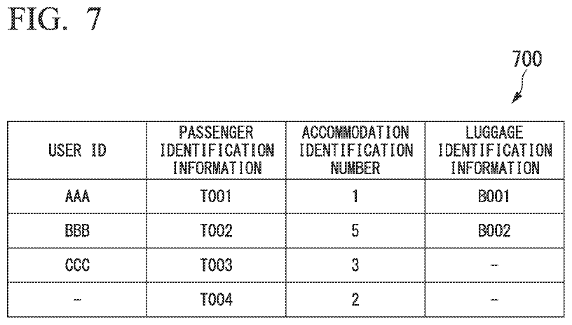

The accommodation control unit 405 controls the accommodation mechanism 421 such that an article detected by the shoes camera 420 is moved. Specifically, the accommodation control unit 405 identifies the rotation base 201 on which the shoes 210 are put. Further, the accommodation control unit 405 unlocks the rotation base 201, controls the biasing spring 303 such that the rotation base 201 is urged downward, and accommodates the shoes 210 in the accommodation casing 301. The accommodation control unit 405 associates identification information of the shoes-accommodation unit 300 (accommodation identification number) accommodating the shoes 210 with identification information of a passenger (passenger identification information). The associated information is stored in a passenger table 700 (see FIG. 7) of the storage unit 410.

The accommodation control unit 405 controls the accommodation mechanism 421 such that the shoes 210 accommodated in the shoes-accommodation unit 300 is moved to the footstep 120 moved to the use position when a passenger gets off the vehicle. Specifically, the accommodation control unit 405 identifies the shoes-accommodation unit 300 accommodating the shoes 210 of a person getting off the vehicle, controls the biasing spring 303 of the identified shoes-accommodation unit 300, moves the rotation base 201 to an upper position, and locks the rotation base 201 at the upper position.

The accommodation control unit 405 controls the rotation mechanism such that the toes of the shoes 210 are oriented in a direction in which the passenger gets off the vehicle until the slide door 110 is opened at the time of alighting and the rotation base 201 is rotated by 180 degrees. In this way, since the direction of the shoes 210 is changed and the shoes 210 are disposed on the footstep 120, the person getting off the vehicle can put on the shoes 210 conveniently.

The accommodation control unit 405 may rotate the rotation base 201 in consideration of the direction of the shoes 210. Specifically, the accommodation control unit 405 determines the toe side and the heel side using an imaging result of the shoes camera 420 and rotates the rotation base 201 by 180 degrees in accordance with a determination result. Thus, when a passenger aligns the direction of the shoes in an alighting direction and gets on the vehicles, the base station 201 can be caused not to be rotated.

### Prevention of Lost Article in Vehicle

Next, the footstep 120 which is no moved to the use position when a person getting off the vehicle leaves an article behind in the vehicle will be described. The vehicle interior camera 430 can also detect an item of luggage of a passenger. The vehicle interior camera 430 is an example of a luggage detection unit. In the embodiment, the vehicle interior camera 430 is used as an example of the luggage detection unit, but the luggage detection unit is not limited thereto. For example, when a wireless tag is attached to an item of luggage, the luggage detection unit may be a sensor that detects the wireless tag.

The luggage detection unit 407 associates identification information of an item of luggage (luggage identification information) detected by the vehicle interior camera 430 with passenger identification information when a passenger gets on the vehicle. The associated information is stored in the passenger table 700 (see FIG. 7) of the storage unit 410. The luggage detection unit 407 detects a left item of luggage of the passenger getting off the vehicle on the basis of a detection result of the vehicle interior camera 430. The detection of the left item of luggage is, for example, detection of an action of a passenger getting off the vehicle and detection of non-movement (leaving) of the item of luggage of the passenger by the action detection unit 406.

The accommodation control unit 405 does not move the shoes 210 to the footstep 120 when the luggage detection unit 407 detects a left item of luggage of a passenger getting off the vehicle. The footstep control unit 403 does not move the footstep 120 to the use position when the luggage detection unit 407 detects the left item of luggage of a passenger getting off the vehicle. The vehicle M does not open the slide door 110 when the luggage detection unit 407 detects the left item of luggage.

Next, report of a lost article when it is determined that there is a left item of luggage of a passenger getting off the vehicle will be described. The report unit 408 reports the leaving of an item of luggage when the luggage detection unit 407 detects a left item of luggage. The report unit 408 reports the leaving of an item of luggage, for example, by a sound from the speaker 440 or display of a display.

### Process Before Boarding Performed by Vehicle M Starts

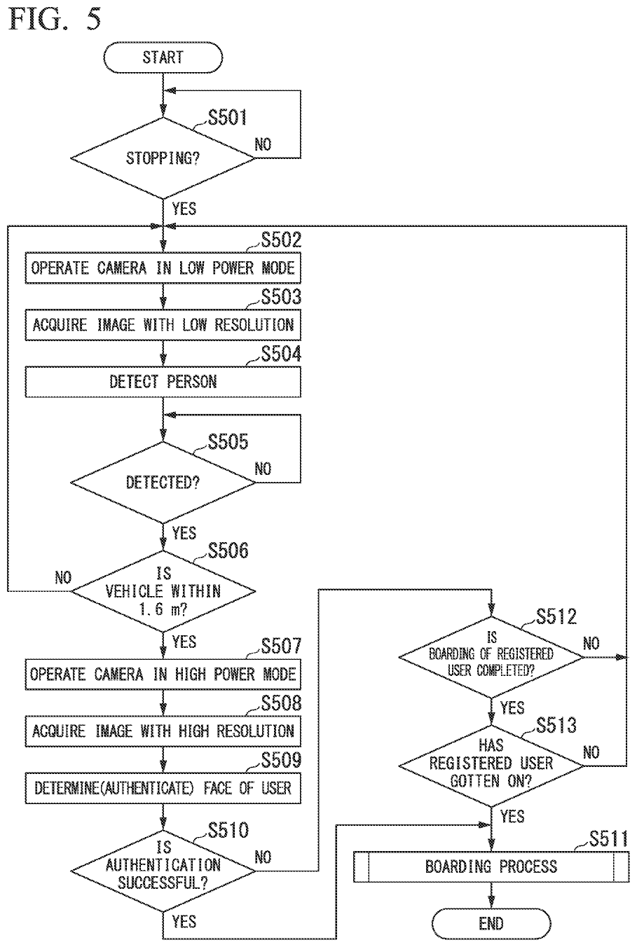

FIG. 5 is a flowchart illustrating an example of a process before boarding performed by the vehicle M starts. In FIG. 5, the person detection unit 401 determines whether the vehicle is stopping (or being parked) at a scheduled location (step S501). The person detection unit 401 waits until the vehicle is stopping at the scheduled location. When the vehicle is stopping at the scheduled location, the person detection unit 401 operates the vehicle exterior camera 100 in the low power mode (step S502).

Subsequently, the person detection unit 401 acquires an image with a low resolution from the vehicle exterior camera 100 (step S503). Then, the person detection unit 401 starts detecting a person using an imaging result of the low resolution (step S504). Then, the person detection unit 401 determines whether the person is detected (step S505). The user determination unit 402 waits until the person detection unit 401 detects the person. When the person is detected, user determination unit 402 determines whether the detected person is within 1.6 m from the vehicle M (step S506).

When the detected person is not within 1.6 m from the vehicle M, the user determination unit 402 returns the process to step S502. When the detected person is within 1.6 m from the vehicle M, the user determination unit 402 operates the vehicle exterior camera 100 in the high power mode (step S507). Further, the user determination unit 402 acquires a face image with a high resolution from the vehicle exterior camera 100 (step S508).

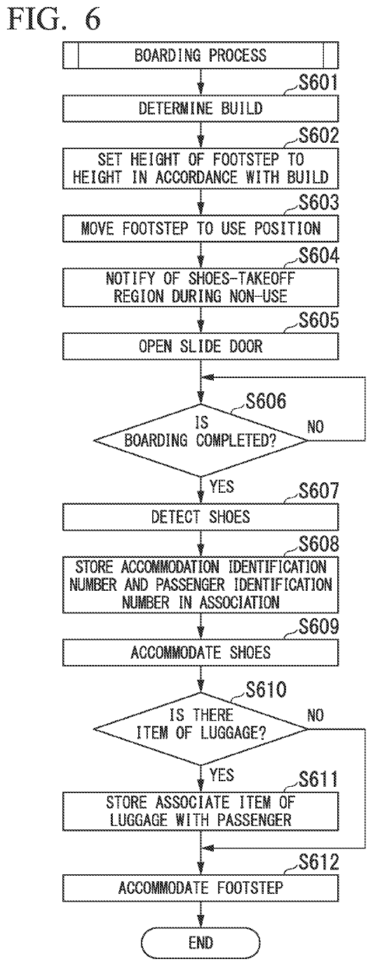

Then, the user determination unit 402 extracts the face image (a feature amount) with the high resolution and determines the face of the user (authenticates the user) (step S509). Subsequently, the user determination unit 402 determines whether the authentication of the user is successful (step S510). The authentication of the user may be performed a plurality of times. For example, when the authentication of the user fails three times, the authentication may be determined to fail. When the authentication of the user is successful, the vehicle M performs a boarding process (see FIG. 6) (step S511) and ends the series of processes.

When the authentication of the user fails in step S510, the footstep control unit 403 determines whether the registered user Us has already gotten on the vehicle M (step S512). When the registered user Us has not yet gotten on the vehicle M, the footstep control unit 403 returns the process to step S502. When the registered user Us has already gotten on the vehicle M, the footstep control unit 403 determines whether the person of which the face is authenticated is allowed to get on the vehicle (step S513).

When the person of which the face is authenticated is allowed to get on the vehicle, specifically, for example, when the person is an acquaintance or the person is an acquaintance and a reply indicating that the acquaintance is allowed to get on the vehicle can be obtained from a passenger (the registered user Us), the footstep control unit 403 causes the process to proceed to step S511. Conversely, when the person of which the face is authenticated is not allowed to get on the vehicle, the footstep control unit 403 returns the process to step S502.

### Boarding Process Performed by Vehicle M

FIG. 6 is a flowchart illustrating an example of a boarding process performed by the vehicle M. In FIG. 6, the build determination unit 404 determines a build of the passenger (step S601). The footstep control unit 403 sets the height of the footstep 120 to a height in accordance with the build determined by the build determination unit 404 (step S602). Then, the footstep control unit 403 moves the footstep 120 to the use position (step S603).

Further, the footstep control unit 403 turns on the lighting member of the shoes-takeoff region 200 corresponding to the shoes-accommodation unit 300 which is not being used in a predetermined lighting pattern and notifies the passenger of the shoes-takeoff region 200 (step S604). Then, the vehicle M opens the slide door 110 (step S605). Subsequently, the accommodation control unit 405 determines whether the boarding of the person permitted to get on the vehicle is completed using an imaging result of the vehicle interior camera 430 (step S606).

The accommodation control unit 405 waits until the boarding of the person permitted to get on the vehicle is completed. When the boarding of the person is completed, the shoes 210 on the footstep 120 is detected using the imaging result of the shoes camera 420 (step S606). Then, the accommodation control unit 405 stores the accommodation identification number of the shoes-accommodation unit 300 accommodating the detected shoes 210 and the passenger identification number in the passenger table 700 of the storage unit 410 in association (see FIG. 7) (step S608). Further, the accommodation control unit 405 accommodates the shoes 210 in the shoes-accommodation unit 300 (step S609).

Then, the luggage detection unit 407 detects whether there is an item of luggage of the passenger using the imaging result of the vehicle interior camera 430 (step S610). When the passenger does not carry the item of luggage, the luggage detection unit 407 causes the process to proceed to step S612. When the passenger carries the item of luggage, the luggage detection unit 407 stores the luggage identification number and the passenger identification number in the passenger table 700 (see FIG. 7) of the storage unit 410 in association (step S611). The footstep control unit 403 closes and locks the slide door 110, accommodates the footstep 120 in the footstep accommodation unit 121 (step S612), and ends the series of processes.

### Example of Passenger Table 700 Stored in Storage Unit 410

FIG. 7 is a diagram illustrating an example of the passenger table 700 stored in the storage unit 410. In FIG. 7, the passenger table 700 indicates information stored after a person of which the face is authenticated gets on the vehicle. The passenger table 700 includes items of a user ID, the passenger identification information, the accommodation identification number, the luggage identification information. The user ID is identification information for identifying the registered user Us. In the user ID, “-” indicates a passenger such as an acquaintance who is not the registered user Us.

The passenger identification information is identification information for identifying a passenger. When the passenger is the registered user Us, the user ID and the passenger identification information may be the same information. The accommodation identification number is identification information of the shoes-accommodation unit 300 accommodating the shoes 210. The luggage identification information is identification information of an item of luggage. In the luggage identification information, “-” indicates that the passenger does not carry an item of luggage.

For example, In FIG. 7, a passenger who is the registered user Us, has a user ID of “AAA,” and has passenger identification information of “T001” and of which the shoes 210 of the passenger is accommodated in the shoes-accommodation unit 300 with an accommodation identification number “1” gets on the vehicle carrying an item of luggage with item of luggage with luggage identification information of “B0001.”

### Process at Time of Alighting Performed by Vehicle M

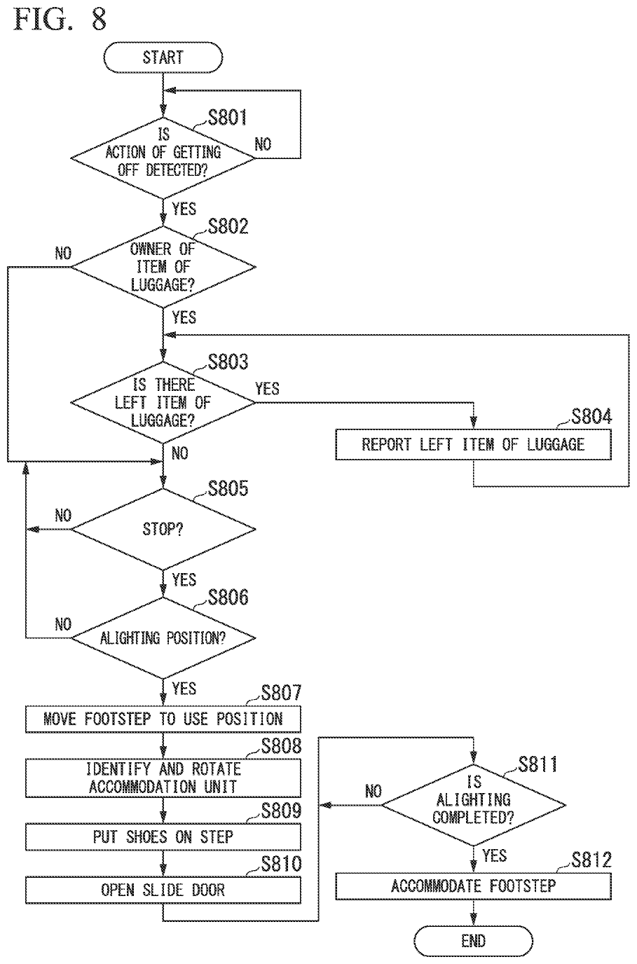

FIG. 8 is a flowchart illustrating an example of a process at the time of alighting performed by the vehicle M. In FIG. 8, the action detection unit 406 determines whether to detect an action of a passenger getting off the vehicle using an imaging result of the vehicle interior camera 430 (step S801). The action detection unit 406 waits until an action of the passenger getting off the vehicle is detected. When the action detection unit 406 detects the action of the passenger getting off the vehicle, the luggage detection unit 407 determines whether the passenger is an owner of the item of luggage with reference to the passenger table 700 (see FIG. 7) (step S802). For example, when the passenger who has the user ID of “AAA” gets off the vehicle, the luggage detection unit 407 determines that the passenger is the owner of the item of luggage because the luggage identification information “B0001” is associated with reference to the passenger table 700.

When the passenger is not the owner of the item of luggage, the luggage detection unit 407 causes the process to proceed to step S805. When the passenger is the owner of the item of luggage, the luggage detection unit 407 determines whether the item of luggage is left (step S803). When the item of luggage is left, the report unit 408 reports the left item of luggage (step S804) and returns the process to step S803.

When the item of luggage is not left, the footstep control unit 403 determines whether the vehicle M stops (step S805). The footstep control unit 403 waits until the vehicle M stops. When the vehicle M stops, the footstep control unit 403 determines whether the vehicle M stops at an alighting position (a destination) (step S806). When the vehicle M does not stop at the alighting position, the footstep control unit 403 returns the process to step S805. When the vehicle M stops at the alighting position, the footstep control unit 403 moves the footstep 120 to the use position (step S807). The height of the footstep at the use position is set to the height which is the same as the height set when the passenger gets on the vehicle.

Then, the accommodation control unit 405 identifies the shoes-accommodation unit 300 of the person getting off the vehicle with reference to the passenger table 700 (see FIG. 7) and rotates the rotation base 201 by 180 degrees (step S808). For example, when the passenger who has the user ID “AAA” gets off the vehicle, the accommodation control unit 405 identifies the shoes-accommodation unit 300 with the accommodation identification number “1” with reference to the passenger table 700 and rotates the rotation base 201 by 180 degrees.

Then, the accommodation control unit 405 disposes the shoes 210 on the footstep 120 moved to the use position by moving the rotation base 201 to the upper position and locking the rotation base 201 at the upper position (step S809). Then, the vehicle M opens the slide door 110 (step S810).

Subsequently, the footstep control unit 403 determines whether the alighting is completed (step S811). The footstep control unit 403 waits until the alighting is completed. When the alighting is completed, the slide door 110 is closed and locked, the footstep 120 is accommodated in the footstep accommodation unit 121 (step S812), and the series of processes is ended.

As described above, in the vehicle M according to the embodiment, when the authentication of the registered user Us is successful, the footstep 120 accommodated in the footstep accommodation unit 121 is moved to the use position, the footstep 120 is accommodated in the footstep accommodation unit 121 after the registered user Us gets on the vehicle. Thus, since the boarding of the registered user Us can be supported with the footstep 120, it is possible to inhibit an uncomfortable posture or an unusual posture of the body when the registered user Us gets on the vehicle. Accordingly, when the user gets on the vehicle, an unconformable posture of the body can be inhibited, and thus the user can get on the vehicle easily. Since the footstep 120 can be accommodated in the vehicle M during driving, it is possible to inhibit the footstep 120 from interrupting driving or the vehicle M from increasing in size.

In the embodiment, in the vehicle M, even if the authentication of the registered user Us fails, the footstep 120 can be moved to the use position when the registered user Us has already gotten on the vehicle. Thus, when an acquaintance other than the registered user Us gets on the vehicle, the footstep 120 can be used for the boarding. Therefore, the acquaintance can also be allowed to get on the vehicle M conveniently.

In the embodiment, in the vehicle M, a build of a person is determined on the basis of an imaging result of the vehicle exterior camera 100 and the height at the use position of the footstep 120 is set to the height in accordance with the determined build. Thus, since the height of the footstep 120 can be set to the height in accordance with the build of a passenger, the passenger can get on the vehicle more conveniently.

In the embodiment, in the vehicle M, the footstep 120 is moved to the use position on the basis of a detection result of an action of a passenger inside the vehicle. Thus, when the passenger gets off the vehicle, the footstep 120 can also be moved to the use position. Accordingly, the passenger can get off the vehicle conveniently.

In the embodiment, in the vehicle M, the shoes 210 detected on the footstep 120 are accommodated in the shoes-accommodation unit 300. Thus, since it is possible to prevent a passenger from accommodating the shoes 210 on a shoes shelf by herself or himself in the shoes shelf or carrying the shoes 210 inside the vehicle, it is possible to reduce a labor of the passenger.

In the embodiment, in the vehicle M, when a passenger gets off the vehicle, an article accommodated in the s shoes-accommodation unit 300 is disposed on the footstep 120 moved to the use position. Thus, even if the passenger does not put the shoes 210 on the footstep 120 by herself or himself, the shoes 210 can be put on the footstep 120. Therefore, it is possible to reduce a labor of the passenger.

In the embodiment, in the vehicle M, when a left item of luggage of a passenger getting off the vehicle is detected, the shoes 210 are not disposed on the footstep 120. Thus, when an item of luggage is left, the passenger is not allowed to get off the vehicle. Therefore, it is possible to prevent the item of luggage from being left.

In the embodiment, in the vehicle M, when it is detected that an item of luggage of a passenger getting off the vehicle is left, the left item of luggage is reported. Thus, it is possible to prevent the item of luggage from being left.

### MODIFIED EXAMPLES

Hereinafter, Modified Examples 1 to 4 of the embodiment will be described. In the following Modified Examples 1 to 4, the content described in the above-described embodiment will be appropriately omitted. Aspects of the above-described embodiment and Modified Examples 1 to 4 can also be appropriately combined.

### Modified Example 1

First, Modified Example 1 will be described. In the above-described embodiment, the footstep 120 in which the plurality of shoes-accommodation units 300 are provided in the footstep casing 122 has been described. In Modified Example 1, each of the plurality of shoes-accommodation units 300 that forms a footstep 900 will be described.

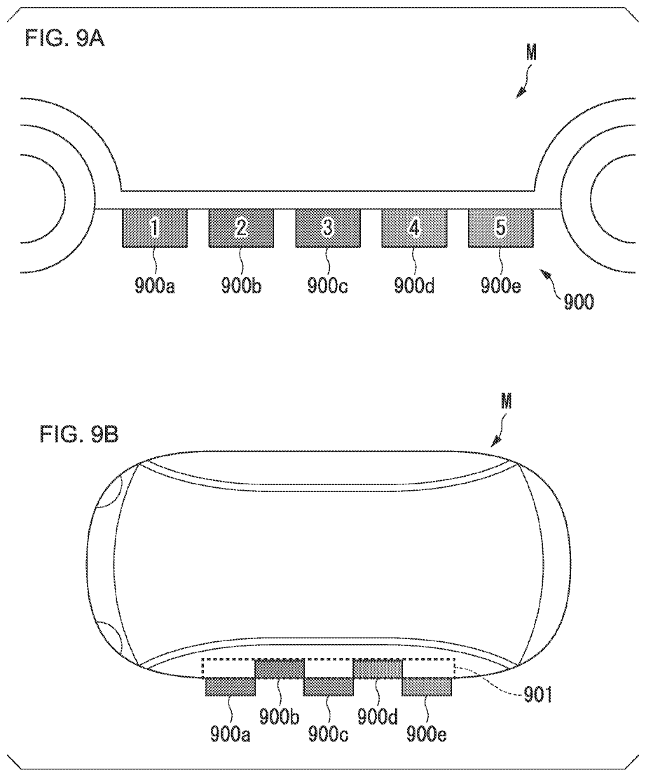

FIGS. 9A and 9B are diagrams illustrating an example of the footstep 900 according to Modified Example 1. As illustrated in FIG. 9A, each footstep 900 (900a to 900e) includes the shoes-takeoff region 200 or the shoes-accommodation unit 300 (the rotation base 201) as in the embodiment. As illustrated in FIG. 9B, the footstep 900 is accommodated in a footstep accommodation unit 901. Each footstep 900 (900a to 900e) can be independently moved.

For example, when the registered user Us gets on the vehicle, the footstep control unit 403 can move the footstep 900 corresponding to the shoes-accommodation unit 300 which is not being used to the use position. In FIG. 9B, the footsteps 900a, 900c, and 900e are moved to the use positions and the footsteps 900b and 900d are accommodated at the accommodation positions.

More specifically, when the registered user Us approaches the vehicle, the footstep control unit 403 can move the footstep 900 corresponding to the shoes-accommodation unit 300 which is not being used to the use position. For example, when three registered users Us approach the vehicle M, it is assumed that authentication of at least one registered user Us is successful. In this case, as illustrated in FIG. 9B, the footstep control unit 403 moves three footsteps 900 (for example, the footsteps 900a, 900c, and 900e) to the use positions. The height of each footstep 900 can be set to a height in accordance with the build of the registered user Us. In this case, the person getting on the vehicle may be informed of the height of each footstep 900 by a sound or the like.

When there is a person who is determined not to be the registered user Us in the user determination and a permission for the person to get on the vehicle is accepted from the registered user Us, the footstep control unit 403 may move the footstep 900 to be used by the person to the use position.

The registered user Us takes off the shoes 210 in the shoes-takeoff region 200 (the rotation base 201) on the footstep 900 and gets on the vehicle M. When the boarding is completed, the accommodation control unit 405 accommodates the shoes 210 in each shoes-accommodation unit 300. When the boarding is completed, the footstep control unit 403 moves each footstep 900 to the footstep accommodation unit 121. Further, the accommodation control unit 405 controls the rotation mechanism of each footstep 900 such that the toes of the shoes 210 are oriented in a direction in which the passenger gets off the vehicle and the rotation base 201 is rotated by 180 degrees before a passenger gets off the vehicle.

The footstep 900 may not include the rotation base 201 and may include a rotation mechanism that rotates the footstep 900 itself by 180 degrees. That is, the footstep control unit 403 may rotate the footstep 900 itself by 180 degrees so that the toes of the shoes 210 are oriented in the direction in which the passenger gets off the vehicle.

According to Modified Example 1, the boarding of the registered user Us can be supported by the footstep 900. Therefore, it is possible to inhibit an uncomfortable posture or an unusual posture of the body when the user gets on the vehicle. Accordingly, when the user gets on the vehicle, an unconformable posture of the body can be inhibited, and thus the user can get on the vehicle easily.

### Modified Example 2

Next, Modified Example 2 will be described. In the above-described embodiment, the footstep 120 including the shoes-accommodation unit 300 has been described. In Modified Example 2, a footstep 1000 that has a simple configuration without including the shoes-accommodation unit 300 will be described.

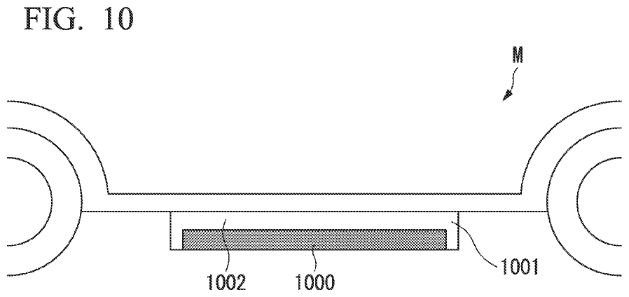

FIG. 10 is a diagram illustrating an example of the footstep 1000 according to Modified Example 2. As illustrated in FIG. 10, the footstep 1000 has a plate shape. The footstep 1000 is accommodated in a footstep accommodation unit 1001. In Modified Example 2, the shoes-accommodation unit 300 is not included and the shoes 210 on the footstep 1000 which a user takes off are also accommodated in the footstep accommodation unit 1001 as they are. Therefore, when a passenger gets off the vehicle, the passenger changes the direction of the shoes 210 by herself or himself and puts on the shoes 210.

As illustrated in FIG. 10, the footstep accommodation unit 1001 guarantees a space 1002 in which the shoes 210 are put. The footstep 1000 can be moved between an advancement position and an accommodation position in the footstep accommodation unit 1001. The height of the footstep 1000 at the use position can be set to a height in accordance with the build of the passenger.

In Modified Example 2, the space 1002 may not be secured. In this case, when a passenger gets on the vehicle M, the passenger holds the shoes 210, gets on the vehicle, and puts the shoes 210 on a shoes shelf inside the vehicle. When a passenger gets off the vehicle, the passenger may take out the shoes 210 from the shoes shelf, place the shoes 210 on the footstep 1000, and put on the shoes 210.

According to Modified Example 2, the boarding of the registered user Us can be supported by the footstep 1000. Therefore, it is possible to inhibit an uncomfortable posture or an unusual posture of the body when the user gets on the vehicle. Accordingly, when the user gets on the vehicle, an unconformable posture of the body can be inhibited, and thus the user can get on the vehicle easily. According to Modified Example 2, since the shoes-accommodation unit 300, the accommodation control unit 405, and the shoes camera 420 may not be included, the configuration can be simple and control can be performed simply.

### Modified Example 3

Next, Modified Example 3 will be described. In the above-described embodiment, the footstep 120 including the rotation base 201 has been described. In Modified Example 3, a footstep 1100 which can be rotated without including the rotation base 201 (the shoes-accommodation unit 300) will be described.

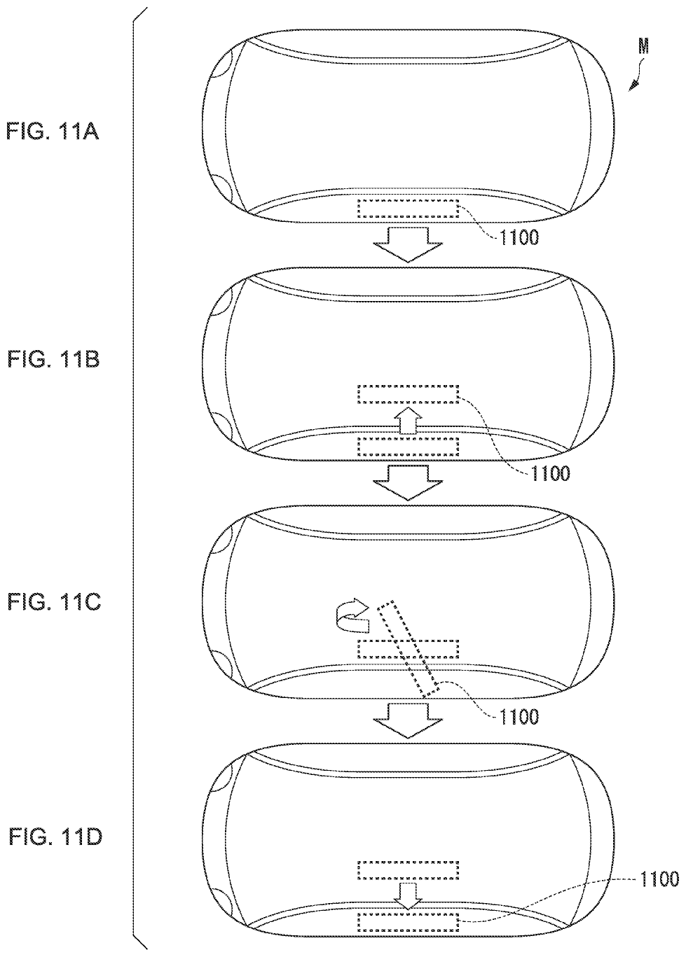

FIGS. 11A to 11D are diagrams illustrating an example of the footstep 1100 according to Modified Example 3. As illustrated in FIGS. 11A to 11D, the footstep 1100 has a plate shape. In Modified Example 3, as in Modified Example 2, the footstep 1100 is accommodated in a footstep accommodation unit (not illustrated) with the shoes 210 on the footstep 1100 taken off.

FIG. 11A illustrates a state in which the footstep 1100 is accommodated with the shoes 210 taken off. The footstep control unit 403 rotates the footstep 1100 together with the footstep accommodation unit so that the direction of the shoes 210 is changed by 180 degrees. Specifically, as illustrated in FIG. 11B, the footstep control unit 403 controls a footstep movement mechanism such that the footstep 1100 is moved close to the middle of the vehicle. As illustrated in FIG. 11C, the footstep control unit 403 controls the rotation mechanism such that the footstep 1100 is rotated about a portion (middle) of the footstep 1100 as a pivot. As illustrated in FIG. 11D, the footstep control unit 403 controls the footstep movement mechanism such that the footstep 1100 is returned to the original position. Thus, the toes of the shoes 210 are disposed to be oriented in the direction in which a passenger gets off the vehicle.

The shorter the length of the footstep 1100 is, the smaller a radius of the footstep 1100 during rotation is. Therefore, when the length of the footstep 1100 is short, a movement distance of the footstep 1100 can be shortened at the time of movement close to the middle of the vehicle, as illustrated in FIG. 11B.

According to Modified Example 3, the boarding of the registered user Us can be supported by the footstep 1100. Therefore, it is possible to inhibit an uncomfortable posture or an unusual posture of the body when the user gets on the vehicle. Accordingly, when the user gets on the vehicle, an unconformable posture of the body can be inhibited, and thus the user can get on the vehicle easily. According to Modified Example 3, since the shoes-accommodation unit 300, the accommodation control unit 405, and the shoes camera 420 may not be included and only the footstep 1100 may be rotated, the configuration can be simple and control can be performed simply. It is possible to prevent a passenger from accommodating the shoes 210 on a shoes shelf by herself or himself or carrying the shoes 210 inside the vehicle when the passenger gets on the vehicle. Therefore, it is possible to reduce a labor of the passenger.

### Modified Example 4

Next, Modified Example 4 will be described. In the above-described embodiment, the footstep 120 including the shoes-accommodation unit 300 has been described. In Modified Example 4, collection of the shoes 210 in an accommodation space inside the vehicle without including the shoes-accommodation unit 300 will be described.

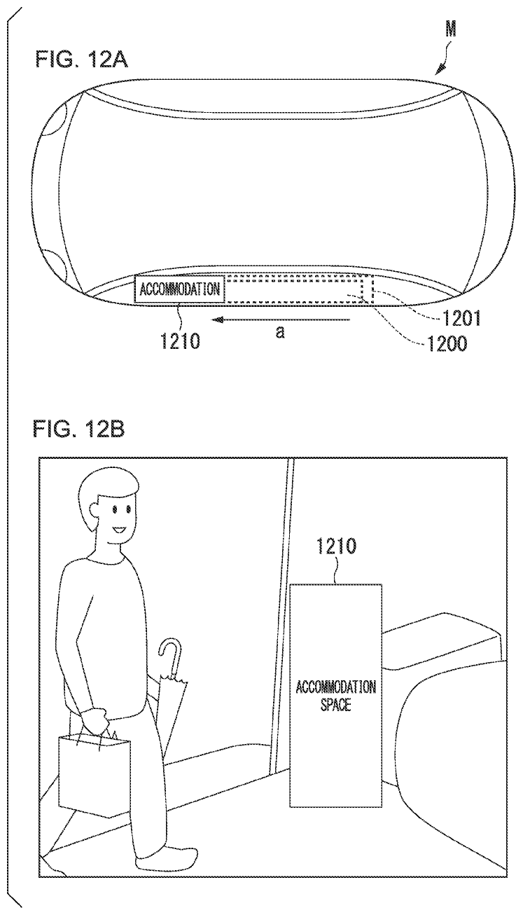

FIGS. 12A and 12B are diagrams illustrating an example of a footstep 1200 according to Modified Example 4. As illustrated in FIG. 12A, the footstep 1200 is configured to be able to transport the shoes 210 on the footstep 1200 in the direction a in the drawing in a footstep accommodation unit 1201. Specifically, the footstep 1200 transports the shoes 210 by providing a roller and rotating the roller. The surface of the footstep 1200 may have a belt shape. Here, the surface of the footstep 1200 is fixed so that there is no hindrance when a passenger gets on or off the vehicle at an advancement position.

When the registered user Us gets on the vehicle, the footstep 1200 is accommodated in the footstep accommodation unit 1201. In the footstep accommodation unit 1201, the shoes 210 are transported to the footstep 1200 and are accommodated in the accommodation space 1210 illustrated in FIG. 12B. The accommodation space 1210 is a space provided in the vehicle. The accommodation space 1210 is, for example, a shoes cupboard.

The shoes 210 accommodated in the accommodation space 1210 may be accommodated in disorder. In Modified Example 4, however, the shoes 210 are accommodated in combination with each passenger. Specifically, the accommodation control unit 405 accommodates the shoes 210 in the accommodation space 1210 in combination with each passenger. When a passenger gets off the vehicle, the passenger takes out the shoes 210 from the accommodation space 1210 by herself or himself. Then, the passenger puts on the shoes put on the footstep 1200 and gets off the vehicle.

According to Modified Example 4, the boarding of the registered user Us can be supported by the footstep 1200. Therefore, it is possible to inhibit an uncomfortable posture or an unusual posture of the body when the user gets on the vehicle. Accordingly, when the user gets on the vehicle, an unconformable posture of the body can be inhibited, and thus the user can get on the vehicle easily. According to Modified Example 4, it is possible to prevent a passenger from accommodating the shoes 210 on a shoes shelf by herself or himself or carrying the shoes 210 inside the vehicle when the passenger gets on the vehicle. Therefore, it is possible to reduce a labor of the passenger.

### Modified Example 5

Next, Modified Example 5 will be described. In the above-described embodiment, the footstep 120 equipped in the vehicle M performing automated driving has been described. In Modified Example 5, the footstep 120 equipped in a vehicle 1300 driven by a user will be described.

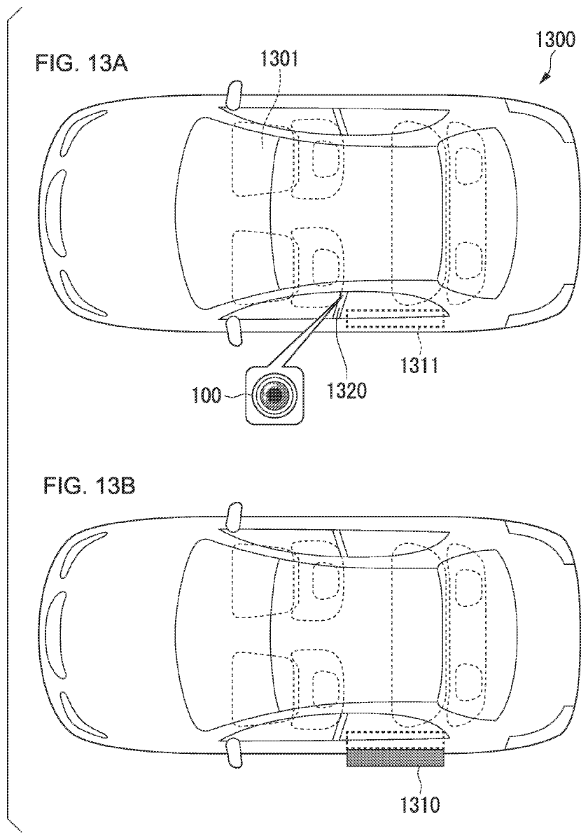

FIGS. 13A and 13B are diagrams illustrating an example of the vehicle 1300 according to Modified Example 5. In FIGS. 13A and 13B, the vehicle 1300 is a vehicle which a person can get on and sit on a driver seat 1301 to perform driving. The vehicle 1300 can also include a vehicle control device supporting driving of a driver to perform automated driving.

The vehicle 1300 includes a footstep 1310 used by a person getting on a rear seat. As illustrated in FIG. 13A, when the footstep 1310 is not used, the footstep 1310 is accommodated in a footstep accommodation unit 1311. In the footstep 1310, the number of shoes-takeoff regions 200 is a number corresponding to a riding capacity of the rear seats and is, for example, “3.”

The vehicle exterior camera 100 is mounted on a center pillar 1320 of the vehicle 1300. The vehicle 1300 performs authentication of the registered user Us when a person approaching the vehicle 1300 is detected on the basis of an imaging result of the vehicle exterior camera 100. When the authentication is successful, as illustrated in FIG. 13B, the footstep control unit 403 moves the footstep 1310 to the use position. When boarding of the registered user Us is completed, the footstep control unit 403 accommodates the footstep 1310 in the footstep accommodation unit 1311.

According to Modified Example 5, the boarding of the registered user Us can be supported by the footstep 1310 in the vehicle 1300 driven by the person. Therefore, it is possible to inhibit an uncomfortable posture or an unusual posture of the body when the user gets on the vehicle. Accordingly, when the user gets on the vehicle, an unconformable posture of the body can be inhibited, and thus the user can get on the vehicle easily.

The embodiments for carrying out the present invention have been described above, but the present invention is not limited to the embodiments. Various modifications and substitutions can be made within the scope of the present invention without departing from the gist of the present invention.

What is claimed is:

1. A vehicle comprising:
a footstep used to get on or off the vehicle;
a driving unit configured to drive the footstep so that at least a part of the footstep is accommodated at an accommodation position hidden in a body of the vehicle;
an imaging unit configured to image a vicinity of the vehicle;
a person detection unit configured to detect a person from an image captured by the imaging unit;
a user determination unit configured to determine whether the person detected by the person detection unit is a registered user who has been registered in advance; and
a first control unit configured to control the driving unit such that the footstep is moved from the accommodation position to a use position at which at least a part of the footstep is exposed to outside of the vehicle when the user determination unit determines that the person is the registered user, and the footstep is moved to the accommodation position after the person gets on the vehicle.

2. The vehicle according to claim 1, wherein, even if the user determination unit determines that the person is not the registered user, the first control unit is able to move the footstep to the use position when the person already determined to be the registered user is getting on the vehicle.

3. The vehicle according to claim 1, further comprising:
a build determination unit configured to determine a build of a person detected by the person detection unit on the basis of an image captured by the imaging unit,
wherein the first control unit controls the driving unit such that a height of the footstep at the use position becomes a height in accordance with the build determined by the build determination unit.

4. The vehicle according to claim 1, further comprising:
an action detection unit configured to detect an action of a passenger inside the vehicle,
wherein, on the basis of a detection result of the action detection unit, the first control unit controls the driving unit such that the footstep is moved to the use position.

5. The vehicle according to claim 1, further comprising:
an article accommodation unit configured to accommodate an article;
an article detection unit configured to detect an article on the footstep;
an accommodation mechanism configured to move the article on the footstep to the article accommodation unit; and
a second control unit configured to control the accommodation mechanism such that the article detected by the article detection unit is moved to the article accommodation unit.

6. The vehicle according to claim 5,
wherein the first control unit controls the driving unit such that the footstep is moved to the use position when a passenger gets off the vehicle, and
wherein the second control unit controls the accommodation mechanism such that an article accommodated in the article accommodation unit is moved to the footstep moved to the use position.

7. The vehicle according to claim 6, further comprising:
a luggage detection unit configured to detect an item of luggage left by a passenger who is getting off the vehicle,
wherein the second control unit does not move the article to the footstep when the luggage detection unit detects the left item of luggage.

8. The vehicle according to claim 1, further comprising:
a luggage detection unit configured to detect an item of luggage left by a passenger who is getting off the vehicle; and
a report unit configured to report the left item of luggage when the luggage detection unit detects the left item of luggage.

9. The vehicle according to claim 1,
wherein the vehicle is an automated driving vehicle; and
wherein the first control unit is able to control the driving unit such that the footstep is moved to the use position when the vehicle is stopping at a scheduled location.

10. A control method causing a computer mounted in a vehicle including a footstep that is used to get on or off the vehicle, a driving unit that drives the footstep so that at least a part of the footstep is accommodated at an accommodation position hidden in a body of the vehicle, and an imaging unit that images a vicinity of the vehicle; the method comprising:
detecting a person from an image captured by the imaging unit;
determining whether the detected person is a registered user who has been registered in advance; and
controlling the driving unit such that the footstep is moved from the accommodation position to a use position at which at least a part of the footstep is exposed to outside of the vehicle when the person is determined to be the registered user, and the footstep is moved to the accommodation position after the person gets on the vehicle.

11. A computer-readable non-transitory that stores a program causing a computer mounted in a vehicle including a footstep that is used to get on or off the vehicle, a driving unit that drives the footstep so that at least a part of the footstep is accommodated at an accommodation position hidden in a body of the vehicle, and an imaging unit that images a vicinity of the vehicle, to perform:
detecting a person from an image captured by the imaging unit;
determining whether the detected person is a registered user who has been registered in advance; and
controlling the driving unit such that the footstep is moved from the accommodation position to a use position at which at least a part of the footstep is exposed to outside of the vehicle when the person is determined to be the registered user, and the footstep is moved to the accommodation position after the person gets on the vehicle.
